(19) United States
(12) Patent Application Publication
(10) Pub. No.: US 2010/0106578 A1
(43) Pub. Date: Apr. 29, 2010

(54) SHAREHOLDER REWARD SYSTEM

(76) Inventors: Michael Gregory Allio, Danville, CA (US); Matthew Ho, San Francisco, CA (US)

Correspondence Address: Vierra Magen Marcus & DeNiro LLP, 575 Market Street, Suite 2500, San Francisco, CA, 94105, US

(21) Appl. No.: 12/606,492

(22) Filed: Oct. 27, 2009

Related U.S. Application Data
(60) Provisional application No. 61/108,993, filed on Oct. 28, 2008.

(51) Int. Cl. G06Q 30/00; G06Q 40/00

(52) U.S. Cl. 705/14.15

(57) ABSTRACT

A system for providing an offer from multiple sources to a user promoting a reward upon satisfying conditions of the offer. The system electronically receives data indicating that a user has selected an offer to receive a reward from an issuer of stock or an intermediary based on stock ownership. Upon identifying the conditions of the offer, the system determines whether the conditions of the offer are satisfied using stock ownership and/or purchase data associated with the user stored in a shareholder database that aggregates ownership information from multiple sources. The stock purchase data stored in the shareholder database represents stock ownership records that are based on multiple sources including among others: purchases made by the user via one or more investment accounts, gifts or grants of stock or convertible instruments, and stock purchased by the user directly from an issuer of stock or on the open-market through the system. When the conditions of the offer are satisfied based on the stock purchase data stored in the shareholder database, the system determines the reward associated with the offer and delivers the reward to the user.

### CLAIM OF PRIORITY

This application claims priority under 35 U.S.C. §119(e) to U.S. provisional patent application No. 61/108,993 titled “Shareholder Interaction Method and System,” which was filed with the U.S Patent & Trademark Office on Oct. 28, 2008.

### BACKGROUND OF THE TECHNOLOGY

Publicly traded companies generally have little or no direct communication with their shareholders, and typically are not able to identify shareholders by name, email or other means of personal identification because of the lack of available data on their shareholders. Generally, a public company's transfer agent maintains the name and addresses, and sometimes additional information, for a small percentage of investors that are “shareholders of record.” But these agents do not integrate the customer data regarding the behavior of investors as customers to give the companies an accurate view of the combined stockholder and customer relationship. Most shareholders do not have record accounts at transfer agents, instead holding their stock at a brokerage or investment account in “street name.” Accordingly, a widely-owned company is able to identify and interact with only a very small number of shareholders due to the fact that shareholder identities are hidden from the company under the current system. This is of particular concern when public companies are attempting to reach shareholders and communicate information relating to the vote of their shares in board elections and in connection with other corporate governance matters.

A street name security is a security of a publicly traded company held electronically or otherwise for the benefit of the underlying owner in the account of a stockbroker. The actual shareholder is referred to as the beneficial owner. Because the shares are held in the name of the stockbroker, the name of the beneficial owner does not appear on the share register. As a result, publicly traded companies do not know the names of their stockholders or have the ability to communicate with them easily or provide rewards or incentives. Instead, publicly traded companies prepare generic communications that are sent to all their stockholders through intermediaries.

### BRIEF DESCRIPTION OF THE DRAWINGS

FIG. 1 is a block diagram depicting the components of one embodiment of a shareholder reward system.

FIG. 2 is a block diagram depicting the components of an exemplary server of the shareholder rewards system shown of FIG. 1.

FIG. 3 is a block diagram of a computer for performing each of the methods described herein.

FIG. 4 depicts a flow chart illustrating one embodiment of a method for delivering a reward to a user.

FIG. 5 depicts a flow chart illustrating one embodiment of a method for providing a second offer to a user.

FIG. 6 depicts a flow chart illustrating one embodiment of a method for verifying whether a user qualifies for a reward associated with an offer.

FIG. 7 depicts a flow chart illustrating one embodiment of a first alternative for delivering an offer to a user.

FIG. 8 depicts a flow chart illustrating one embodiment of a second alternative for delivering an offer to a user.

FIG. 9 depicts a flow chart illustrating one embodiment of a method for delivering regulatory documents to a user.

FIG. 10 depicts a flow chart illustrating one embodiment of a method for delivering an offer and reward based upon receipt of a new offer.

FIG. 11 depicts an exemplary offer.

### DETAILED DESCRIPTION

The technology disclosed herein permits publicly traded companies to link their shareholder and customer base to enhance shareholding activity by customers or customer activity by shareholders. The technology facilitates a variety of increased interaction, including providing a platform for a public company to create a direct stock purchase plan whereby the public company provides offers for rewards based on share ownership or purchases that are intended to incentivize the public company's customers to purchase company stock. The technology also allows public companies to confirm and/or identify beneficial owners in street-name accounts. This allows the company to communicate directly with their customers, provide rewards or generate a direct stock purchase plan or other security plan offer, including purchases that would make current shareholders eligible for rewards. In some embodiments, eligibility for offers is based exclusively on stock purchases made through a direct stock purchase plan either from purchases of stock directly from the company or through purchases made on the open market. In other embodiments, eligibility of offers is determined by confirming stock holdings via third-party financial services companies.

Offers are delivered to users to incentivize stock purchases directly from a company. An offer may be based on any combination of shareholder data, consumer data or other data that can be verified, and can also be conditioned on combinations of user behavior. In addition, an offer may be presented to a user in many different forms. By way of example only, an offer may be presented electronically to a user in the form of a banner advertisement on the public company's website or a third-party website, an email message delivered to the user from the public company (e.g., a mailing list of the public company), a text message, and the like. An offer may also be presented to a user via regular mail (e.g., a public company catalogue) or any other method of direct marketing advertising consistent with applicable securities law and other regulations.

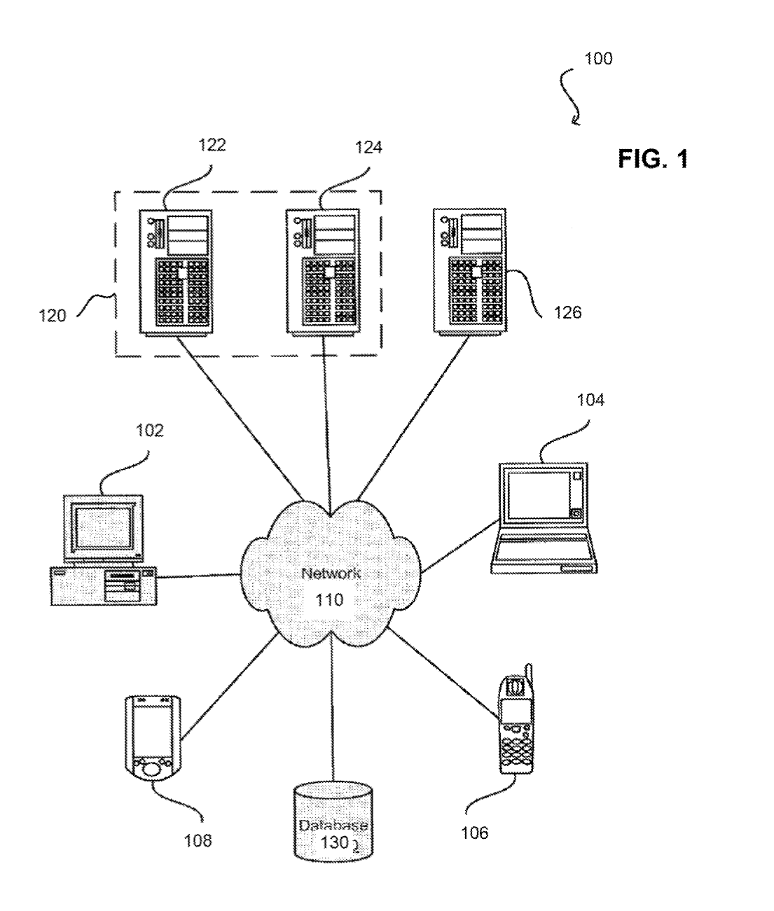

FIG. 1 is a block diagram depicting an exemplary set of components that can be used to implement a shareholder rewards system. System 100 includes one or more processing devices 102, 104, 106, 108, which can be used to operate a dedicated application, web browser, etc. The processing devices shown in FIG. 1 include a personal computer 102, a laptop computer 104, a mobile phone 106 and a smart phone 108. These processing devices are exemplary, and are not intended to limit the scope of the technology described herein. Other exemplary processing devices include, but are not limited to, an Internet-enabled gaming system, a personal messaging device, a personal digital assistant, a set top box, a television, an electronic book reader, or any other electronic device capable of communicating via a network and displaying and navigating web pages or other types of electronic documents.

Each of the processing devices communicates with a shareholder system 120 via the network 110. Network 110 may be any type of network that can support data communications using any of a variety of commercially available protocols. By way of example only, the protocol used to communicate between processing device 102, 104, 106, 108 and shareholder system 120 via network 110 may include, but is not limited to, TCP/IP, SNA, IPX, AppleTalk, and the like. In some embodiments, network 110 may be a local area network (LAN), such as an Ethernet network, a token-ring network, or a wide area network (WAN). In one example, network 110 includes the Internet.

Shareholder system 120 facilitates a variety of increased interaction, including providing a platform for a public company to create a direct stock purchase plan whereby the public company provides offers for rewards based on share ownership or purchases that are intended to incentivize the public company's customers to purchase company stock. Shareholder system 120 includes a first server 122 and a second server 124. Shareholder system 120 may include one or more server computers, be a server farm, or comprise any other arrangement of servers know in the art. The servers in system 120 may be running any commercially available server operating system. A server may also run any of a variety of server applications and/or mid-tier applications, including HTTP servers, FTP servers, CGI servers, database servers, Java servers, business applications, and the like. A server application may be implemented as one or more scripts or programs written in any programming language, such as Java, C, C# or C++, and/or any scripting language, such as Perl, Python, Ruby, or TCL, as well as combinations of any programming/scripting languages.

Shareholder system 120 has access to a remote server 126. As will described in more detail later, shareholder system 120 has the ability to store user information (e.g., personal information, account information, etc.), but may rely in part (or completely) on remote server 126 to access information (at the consent of the owner) associated with the user and conduct financial transactions. By way of example only, remote server 126 may be affiliated with an account associated with a user such as, but not limited to, a brokerage account, a bank account, a credit card account, a loyalty program account, and the like. Remote server 126, when used to conduct a financial transaction, may include an Automated Clearing House (ACH) network, a credit card processing network (e.g., VISA network, MasterCard network, etc.), or any other payment network known in the art. Remote server 126 may also represent a server at a company (also referred to herein as an “issuer”) or a third-party vendor. The company server interfaces with system 120 to provide offers, register with system 120, receive user behavior information, and the like. A third-party vendor, such as a fulfillment house, may be used by the company or a public company to provide rewards.

System 100 also includes one or more databases 130. FIG. 1 illustrates a single database 130 for illustration purposes only. More than one database 130 may exist in system 100. It is within the scope of the technology described herein for database(s) 130 to reside in one or more of servers 122, 124 in shareholder system 120 or for database 130 to be a remotely located server.

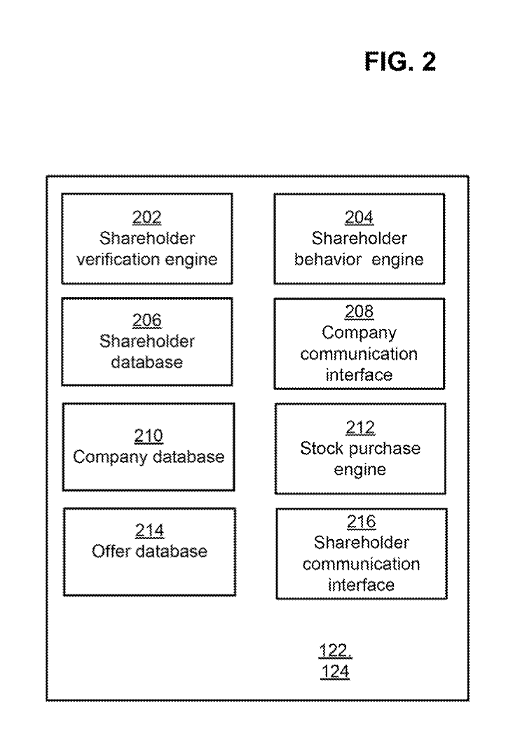

FIG. 2 illustrates an exemplary embodiment of servers 122, 124. Servers 122, 124 include a shareholder verification engine 202, a shareholder behavior engine 204, a shareholder database 206, a public company communication interface 208, a public company database 210, a stock purchase engine 212, an offer database 214 and a shareholder communication interface 216, all of which may be implemented in software, hardware or a combination of software and hardware. Servers 122,124 are not required to have the same architecture, and may include any combination of the elements shown in FIG. 2.

Shareholder verification engine 202 performs account validation checks against a user's brokerage, bank and other investment accounts and obtains available stock ownership (or purchase) data from these accounts. In some embodiments, stockholder verification engine 202 obtains the data by accessing the brokerage and/or investment accounts associated with the user. In other embodiments, data is obtained from the brokerage (or other investment account) via a data feed with broker/investment account. As will be discussed later, stockholder verification engine 202 may verify/update the information periodically or based on certain events.

Shareholder behavior engine 204 tracks user behavior. By way of example only, engine 204 may track when a user purchases a company product (in response to an offer). A product or service may be purchased from the company through system 120 or directly from the company's website. Other examples include tracking a user's purchasing behavior via an account that is accessible via system 120 (e.g., obtain credit card or other spending history of the user). Another example includes tracking which rewards a user responds to (as offered through system 120). Yet another example includes tracking shareholder buying/selling behavior such as the frequency of share purchases, the length shares are held, number of issues held, frequency of sells, etc. Another example includes tracking shareholder behavior such as frequency of participation in proxy votes, likelihood to read financial materials provided by the company, and the like. Shareholder behavior engine 204 may aggregate the tracked behavior of a user (or users) from a variety of distributed access points and provide the information to a company. In some embodiments, engine 204 aggregates information stored in database 206. In other embodiment, engine 204 aggregates information from third-party sources of information (e.g., user's investment accounts, credit card accounts, etc.). Engine 204 may also aggregate information from a combination of database 206 and third-party sources of information.

Shareholder database 206 stores a user profile record for each registered user. By way of example only, a user profile record may contain data related to a user's checking account, savings account, credit card accounts, loyalty programs, email accounts, PayPal account, and any other online accounts, stock ownership data, purchase information, as well as other types of information. A user profile may also include information such as address on record, type of account (e.g., individual, joint, etc), the beneficiaries of the account, and any other data about an account. During registration with system 120, a user enters access information for each account that is required to access the particular account (e.g., URL, and username and password). This way, verification engine 202 may access the account and obtain the relevant information from the account (e.g., number of shares of stock). In some embodiments, data is periodically obtained from each account and is imported into shareholder database 206. It is within the scope of the technology described herein for a user to enter less account information. It is also within the scope of the technology to access each investment account only when data is required for verification.

Company communication interface engine 208 provides an interface and communication channel for a company to access and operate with system 120. As will be described later herein, a public company registers with system 120 and provides certain information to system 120 during registration. Company database 210 stores data provided by each registered company. In some embodiments, a company registers with system 120 and provides the following information during registration: (i) an Originating Depository Financial Institution (ODFI) to route Automated Clearing House (ACH) payments from a shareholder's investment account to bank accounts established for the purpose of share purchases under a direct stock purchase plan or other security plan, and credits from share sales to user accounts, (ii) a broker to allow sales of stock to be routed individually or in batch mode by shareholder, and allow purchases to be routed to open market individually or in batch mode if the public company is not selling treasury stock, (iii) a process for triggering electronic book-entry share movement from the public company's primary transfer agent for user purchases of treasury shares from the public company, and (iv) a quote provider for pricing company stock.

Stock purchase engine 212 conducts a stock transaction in a direct stock purchase plan. If conditions of an offer are met, funds are moved from the user's account (e.g., investment account, bank account, etc.) or using other payment system to a special purpose bank account to forward funds to the public company, and the purchased stock is, in the case of shares purchased directly from the public company moved by electronic transfer to a brokerage account and per-user transactions and holdings are reflected on the system as held in book entry form for the user. In stock transactions where public company shares of stock are purchased on the open market, the funds transfer from the user is the same as described above and funds for the share purchase are electronically delivered to a broker designated by the company and per-user transactions and holdings are reflected on the system as held in book entry form for the user. In this case, stock purchase engine 212 sets the routing of the funds to the broker and the purchasing of shares in the brokerage account. Stock purchase engine 212 may perform account validation checks which may use external validation feeds and internal databases including, but not limited to, blacklist, trial deposits, test debit, bank site access, account formation checks, direct banking relationship validation, voided check delivery, a third party OFAC checking service, bank number routing databases, consumer reporting databases, and any other third-party verification methods known today. Stock purchase engine 212 may also schedule payments through an external payment provider (e.g., ACH) in batch or individually as required by the stock purchase transaction.

Offer database 214 stores offers (also referred to herein as “promotions”) deposited into system 120 by registered public companies (also referred to as an “issuer”). The public company providing the offer sets the condition(s) that must be satisfied before the reward associated with the offer is delivered to a shareholder. An issuer also determines the amount of the reward (e.g., a $100 gift card, $50 cash-back rebate on purchases, 20% discount on next purchase, etc.) associated with the offer.

Offers may be stored in offer database 214 is various ways. For example, in the United States, the Committee on Uniform Security Identification Procedures (CUSIP) bureau number and the stock symbol of a publicly traded company is unique (e.g., no two classes of stock have the same CUSIP identifier and no two companies are listed on the New York Stock Exchange with the same stock symbol). The technology described herein is not limited to unique identifiers used in the United States. In some embodiments, a unique identifier is associated with each stock symbol and the unique identifier is stored as part of an offer record in the offer database 214. In order to be able to track or identify each offer placed in offer database 214, each offer is also associated with a unique offer identifier and stored with the offer record. Thus, two offer records for two different offers from the same company will each have the same unique identifier associated with the company's stock symbol, but will have different offer identifiers. As will be described in more detail later, an offer may be delivered to a user via several different means (e.g., as part of a data feed at a financial information site or at the site of their broker or other financial account provider, text message, email message with a URL to the offer stored in offer database 114, etc.).

In some embodiments, an offer may have a tiered reward. By way of example only, a reward may be a percent discount off of a product, service or stock based on the number of shares owned by a shareholder, a discount off of a product, service or stock based on the amount of time a shareholder has owned the stock, or any other condition determined by the issuer (e.g., number of products purchased, etc.). A reward may also be a discount code for use upon checkout on the company's website (e.g., a discount code a user may enter during the checkout process, e.g., 20% off entire order). A reward may also be shares of stock (e.g., receive 10 shares of stock if the user's next purchase from the company exceeds $1,000, user's next purchase is a specific item, etc. Rewards are not restricted to discounts or other pecuniary benefits. For example, a reward may be an invitation to a store opening, an opportunity to purchase a product before it is released to the general public, special products that are restricted in distribution (perhaps exclusively to users) and the like. These types of rewards are exemplary only, and are not intended to limit the scope of the technology described herein.

A reward may comprise any number of incentives such as, but not limited to, cash (e.g., receive $20 rebate upon any retail purchase of $100 or more), an electronic discount coupon (e.g., type in OWNER 15 at checkout to receive 15% next online purchase), a discount coupon (e.g., 10% off next purchase at Company A store), a gift card (e.g., $20 gift card), an invitation to attend an event (e.g., attend opening of a new store), an invitation to purchase a product before the general public (e.g., purchase an electronic device or designer products before they are available in the store), and the like. These rewards are exemplary only, and are not intended to limit the scope of the technology described herein.

Shareholder communication interface 216 allows users to register with system 120, purchase shares of stock directly from a registered company, receive offers from a registered company, receive rewards from a registered company, and the like. System 120 may communicate with a registered user via electronic mail, regular mail, telephone, instant messaging, text messaging, and the like. Communications may include, but are not limited to, offers, rewards, SEC regulated communications from the public company (e.g., annual reports and proxy statements) as well as confirmations of transactions from the public company prepared on the system, and communications from the company regarding the user's system account.

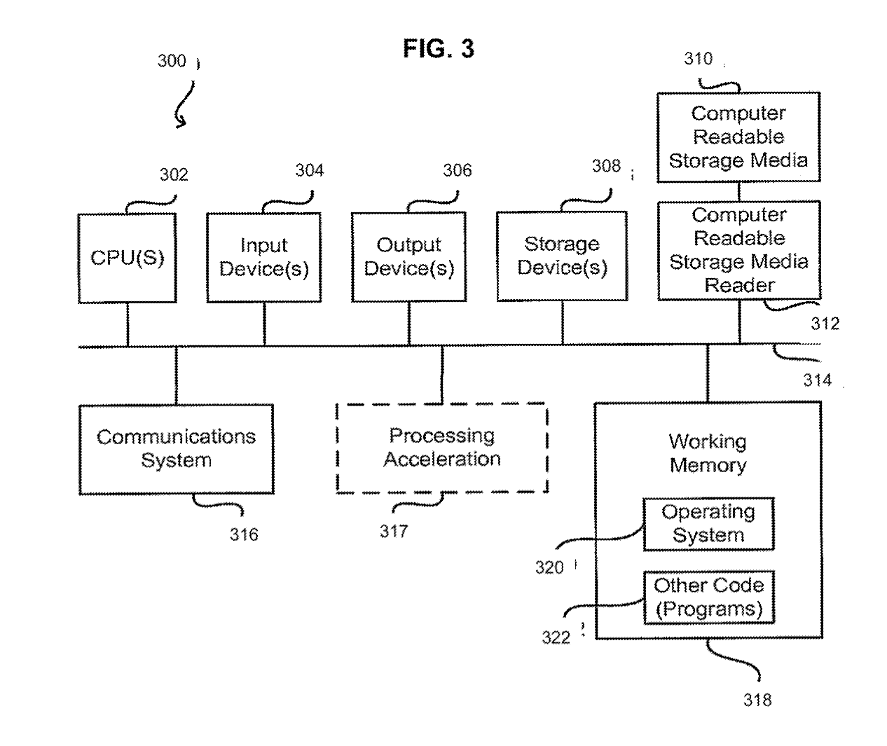

FIG. 3 illustrates a computer system 300 in which various embodiments of the present technology may be implemented. System 300 may be used to implement any of processing devices 102, 104, 106, 108 or server 122, 124. The elements of system 300 include one or more central processing units (CPU) 302, one or more input devices 304 (e.g., mouse, keyboard, etc.) and one or more output devices 306 (e.g., display, printer, etc.), and one or more storage devices 308. By way of example only, a storage device 308 may include a disk drive, optical storage device, solid-state storage device (e.g., random access memory, read-only memory).

The system 300 may also include a computer-readable storage medium 310, a communications system 314 (e.g., modem, network card, etc.), and working memory 318 (e.g., RAM, ROM). In some embodiments, the system 300 may also include a processing acceleration unit 317, which can include a digital signal processor (DSP), a special-purpose processor, and the like.

The computer-readable storage medium reader 312 may further be connected to a computer-readable storage medium 310, together (and optionally, in combination with storage devices 308) comprehensively representing remote, local, fixed, and/or removable storage devices plus storage media for temporarily and/or more permanently containing computer-readable information. The communications systems 314 may permit data to be exchanged with the network and/or any other computer described above with respect to system 300.

Storage media 310 and computer readable media for containing code, or portions of code, can include any appropriate media know or used in the art, including storage media and communications media, such as, but not limited to, volatile memory, and non-volatile memory. The computer system 300 may also comprise software elements, shown as being currently located within a working memory 318, including an operating system 320 and/or other code 322, such as an application program (which may be a client application, Web browser, mid-tier application, RDBMS, etc.). It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

As discussed above, an offer may be promoted via a banner advertisement or text link at a financial content site, a brokerage site or search engine or at a landing page on a public company website page, via an email, a text message, and the like. For discussion purposes only, suppose a landing page is placed on Company A's homepage advertising an invitation to a shareholder-only event to anyone that owns more than 1,000 shares of Company A stock. The advertisement is considered an offer to purchase Company A stock directly from Company A without an underwriter. The shareholder-only event is considered the reward associated with the offer.

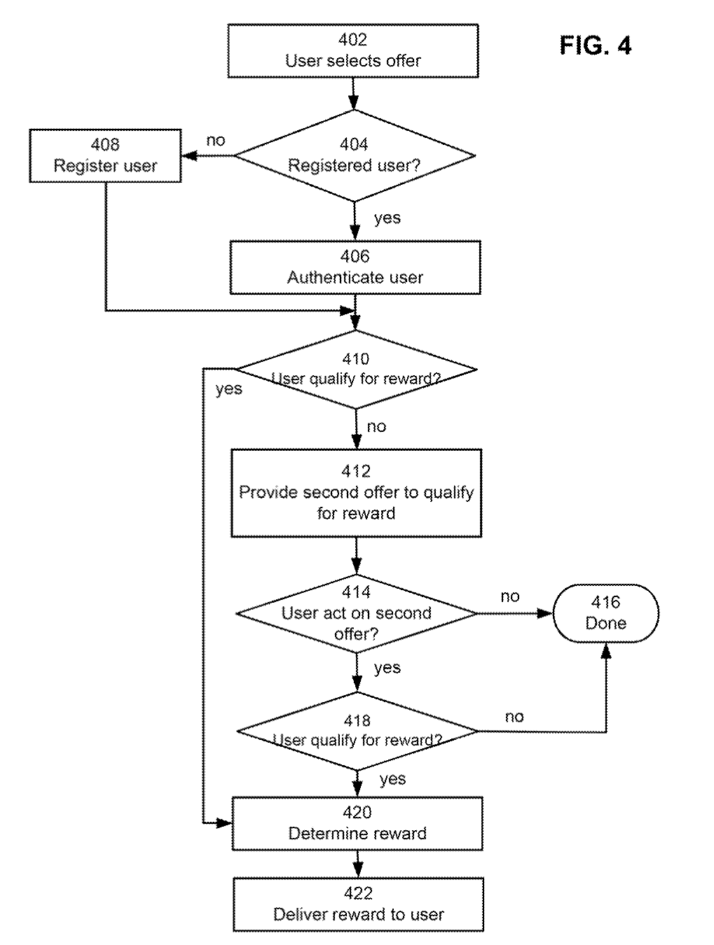

FIG. 4 illustrates exemplary steps for delivering a reward (also referred to herein as an “incentive”) to a user based on the user selecting an advertisement. At step 402, the user selects the offer (e.g., selects that advertisement). Upon selection of the offer, system 120 begins the process of determining whether the user qualifies for the reward based on satisfying the conditions associated with the offer. In this example, the user must own 1,000 shares of Company A stock to qualify for the reward. If the user owns 1,000 shares of Company A stock, the user qualifies, but if not, the user must purchase Company A stock to qualify for the invitation. Depending on the conditions of the offer, the shares can be held or purchased only in a direct purchase account or via an existing brokerage or other financial account that can be measured by the system. System 120 makes a determination whether a user should receive a reward based on the data contained in the user profile stored in the shareholder database 206.

At step 404, system 120 determines whether the user is a registered user. In some embodiments, a user is directed to a login page upon selection of an offer. The login page requests the user to login into system 120 or, if not a registered user, register with system 120. If the user is registered with system 120, the user may enter their username and password and system 120 authenticates the user, at step 406. If the user selected the offer on Company A's website while logged into system 120, system 120 recognizes that the user is a registered user, at step 404.

If the user is not registered with system 120, the user registers with system 120, at step 408. By way of example only, a user registers with system 120 by entering personal information such as, but not limited to, an email address, a password, contact information, personal information (e.g., social security number, date of birth, address, etc.), and the like, and investment account information (e.g., bank account, brokerage account, credit card account, etc.). The personal information and investment account information create the user profile. Once the user has registered with system 120 (or the user has been authenticated), it is determined whether the user qualifies for the reward (e.g., invitation to shareholder-only event) associated with the offer that was selected by the user, at step 410.

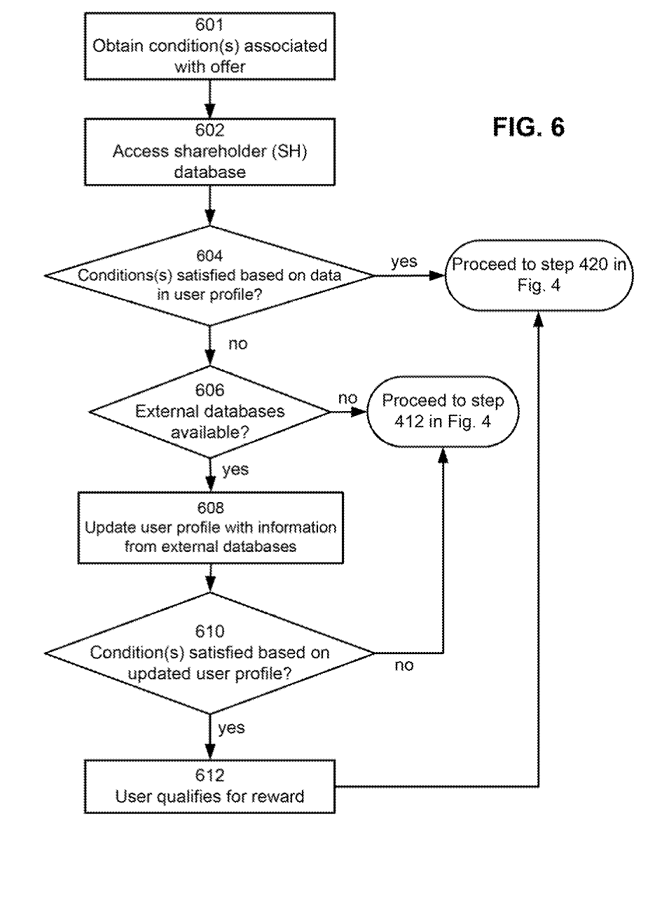

FIG. 6 provides additional detail of step 410. At step 601, system 120 obtains the conditions of the offer. In some embodiments, the condition may require a user to own a minimum number of shares of company stock. In other embodiments, the condition may be to purchase 1,000 new shares of a company stock under a direct stock purchase plan established by the company or in an existing brokerage or other financial account that is measurable (and verifiable) by system 120. Other types of conditions may extend beyond share ownership and may, e.g., focus on consumer activity such as purchase of a certain product/service. These exemplary conditions are not intended to limit the scope of the technology described herein.

Using the example provided above, the condition that must be met to receive an invitation to the shareholder-only event is that a user must own 1,000 shares of Company A stock. At step 602, the user profile associated with the user is accessed by shareholder verification engine 202, and the number of shares of Company A stock owned by the user is identified. The number of shares of Company A stock identified at step 602 is compared to the minimum number of shares designated in the condition (e.g., 1,000 shares), at step 604. If the user owns 1,000 shares of Company A stock (or more), system 120 proceeds to step 420 (see below) to determine the reward.

If the user owns less than 1,000 shares of Company A stock (based on the data available in the user profile associated with the user), system 120 determines if the user profile contains any data related to an investment account, at step 608. As discussed above, a user, when registering with system 120 (or upon updating the user profile), may enter third-party investment account information (e.g., brokerage, bank or other financial accounts), which is stored as well as updated in the user's user profile in shareholder database 206. Thus, at step 608, system 120 identifies any third-party investment accounts associated with the user in shareholder database 206. For example, a user is not limited to purchasing Company A stock directly from Company A through system 120. It is possible that the user purchased Company A stock through their personal brokerage or other financial intermediary account using a third-party financial services firm. If the third-party account information is stored in the user's user profile, system 120 identifies the account, at step 608.ⁱ

If an investment account is identified in the user profile record (and the access data is available to system 120), system 120 retrieves stock purchase data from the investment account and updates the user profile record stored in shareholder database 206 with the newly acquired data, at step 612. Using the example of a brokerage account (but may include a bank, transfer agent, mutual or index fund, or any form of ownership account whether foreign or U.S.), system 120 accesses the user's brokerage account using the login information provided by the user and stored in the user profile. In some embodiment, a user provides the access information (e.g., username and password) during registration. In other embodiments, system 120 prompts the user for their username and password as part of step 612. System 120 imports stock holding and purchase data from the user's brokerage account (e.g., stock positions, purchase dates, etc.) and updates the user profile stored in shareholder database 206. By importing this data, the user's user profile includes the most recent stock holding positions owned by the user. As discussed above, when the stock purchase data is maintained by the user's brokerage account, the public company generally does not have the ability to identify the individual shareholder because the stock in held in street-name form. Importing the stock purchase data from the user's external investment accounts and associating the data with a user allows system 120 to identify individual shareholders and their holdings. Thus, companies that register with system 120 may use system 120 to communicate directly with their shareholders for both corporate shareholder and customer purposes.

At step 614, shareholder verification engine 202 determines if the condition(s) of the offer is satisfied based on the updated information contained in the user profile. Using the example provided above, shareholder verification engine 202 compares the number of shares of Company A stock owned by the user (as indicated in the user profile in shareholder database 206) to the minimum number of shares designated in the rule. If the user owns at least 1,000 shares of Company A, system 120 identifies that the user satisfies the conditions of the offer, at step 616, and proceeds to step 420 (see below) to determine and deliver the reward.

If the user profile in shareholder database 206 does not contain any investment accounts associated with the user, at step 608, or it is determined, at step 614, that the user does not own at least 1,000 shares of Company A stock (based on the updated information stored in user profile in shareholder database 206), system 120 proceeds to step 412 (see below) to inform the user that additional shares are required for eligibility for the offer.

Returning to FIG. 4, if the user does not qualify for the reward, system 120, in some embodiments, provides the user with an opportunity to qualify for the reward, at step 412. Using the example above, if the user that selected the advertisement does not own 1,000 shares of Company A, system 120 may deliver a notice to the user regarding the additional shares needed to be purchased and may permit the user to purchase the shares of Company A stock through the system, or through an intermediary financial account, such as a brokerage, that can be verified by system 120, to qualify for the invitation-only event. At step 414, it is determined whether the user accepted and acted on the second offer. If the user did not purchase at least 300 shares of Company A stock, at step 414, system 120 ends the reward process, at step 416. Using the example provide above, if the user purchased at least 300 additional shares of Company A stock either directly or through a verified source, the stock purchase data is added to the user's user profile in shareholder database 206. In some embodiments, the shares of stock are purchased from the public company or in open-market purchases under the company's plan via system 120. In other embodiments, the user purchases shares of stock using their personal third-party brokerage account or other financial intermediaries. At step 418, verification engine 202 verifies that the user now owns at least 1,000 shares of Company A stock.

At step 420, the reward for satisfying the conditions of the offer is determined. In some embodiments, the company that provided the offer may associate multiple potential rewards with a single offer. By way of example only, a single offer may advertise different reward opportunities that are dependent on conditions set in system 120. By way of example only, the reward may be a 10% discount on the next purchase of Company A products if the user owns 100 shares of Company A stock, a 15% discount on the next purchase if the user owns 300 shares of Company A stock, and so on. In other embodiments, a single offer is associated with a single reward, which can be made regardless of the user's level of stockownership. System 120 is very flexible and allows an offer to be associated with any conceivable set of conditions for a user to meet to obtain product or stock rewards based on desired behaviors or actions of the user. System 120 identifies the offer record in the offer database 214 and identifies the corresponding reward in the record.

At step 422, delivery of the reward is triggered. A reward may be delivered to a user via any communication channel known in the art. By way of example only, a reward may be delivered to a user via email, a text message, regular mail, or other means. In some embodiments, a reward is delivered to the user's account (e.g., inbox) maintained by system 120. In other embodiments, the reward is delivered to a processing device associated with the user (e.g., mobile phone, laptop, etc.). In other embodiments, the public company or third party aggregator providing the offer may deliver the reward to the user and the reward is not delivered to the user by system 120. In this instance, system 120 delivers a notification to the public company that the particular user qualifies for the reward and that the public company should deliver the reward to the user. In yet other embodiments, system 120 delivers a notification directly to a third-party fulfillment service used by the company or aggregator to deliver rewards on behalf of the company to qualified users.

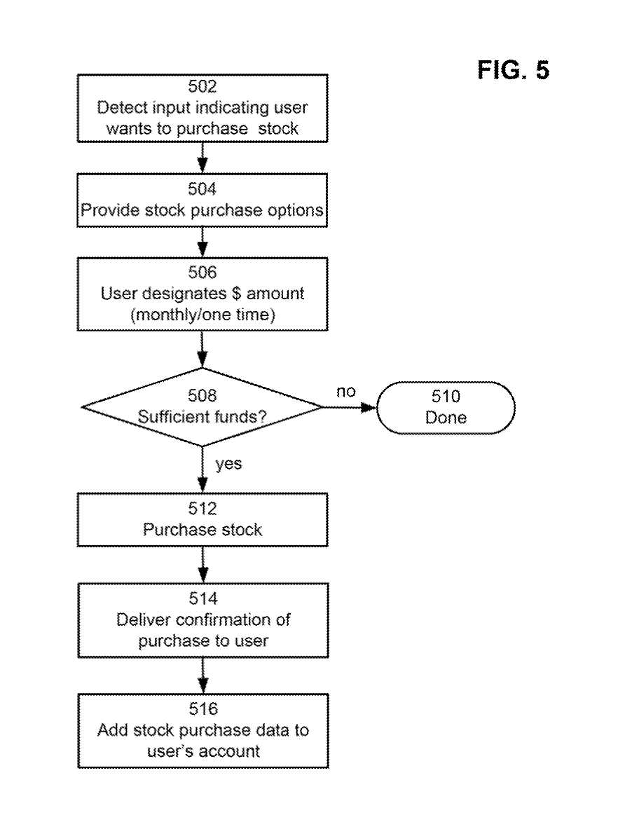

FIG. 5 provides additional detail of providing a second offer (step 412 in FIG. 4). Using the example provided above, a second offer may be delivered to the user to purchase additional shares of Company A stock in order to receive the invitation to the shareholder-only party. At step 502, user input is detected indicating that the user wants to purchase additional shares of Company A stock. System 120 may execute either a treasury stock purchase or an open market stock purchase. In a treasury stock purchase, system 120 verifies the validity of the account the funds are to be debited from prior to executing the trade. In some embodiments, system 120 verifies an account by verifying that the routing number associated with the account is valid and belongs to a particular financial institution. In other embodiments, system 120 verifies an account by using a heuristic that determines a security score for the particular stock transaction. In an open market stock purchase, system 120 verifies that sufficient funds have been received from the user prior to the stock transaction's taking place.

The stock purchase choices are provided to the user, at step 504. In some embodiments, the user may be presented with several stock purchase choices. By way of example only, the user may be presented with two choices: a one-time purchase (e.g., designate either the number of shares or a dollar total) and a monthly recurring debit (e.g., automatically debit $100 per month). Other stock purchase choices may be presented to the user at step 504. The term “stock” used throughout may refer to common stock or preferred stock.

At step 506, the user designates the amount of the investment. Depending on the stock purchase choices provided to the user, the user may designate a one-time dollar amount, a number of shares, a monthly debit, and so on. The user submits the purchase request and, at step 508, stock purchase engine 212 verifies that the user's account has sufficient funds (if an open market stock purchase). In some embodiments, the user designates the investment account that should be debited to purchase the stock. Investment accounts may include, by way of example only, a bank account (savings, checking, etc.), a brokerage account, etc. If insufficient funds are received from the user to pay for the stock purchase, the stock purchase is cancelled, at step 510.

Using the open-market stock purchase scenario, if there are sufficient received from the user, the stock is purchased, at step 512. Any method known today for purchasing stock and recording the stock purchase may be used to conduct the transaction at step 512. In some embodiments, as discussed above, a public company registers with system 120 and designates (i) an ODFI or other financial institution account for users to route payments from the users' account to pay for the purchases either by payments to the public company for treasury securities or payments to a brokerage firm to enter into open-market transactions for the purchases of shares, (ii) a brokerage account for share purchases, sales, and holding and (iii) information required for electronic book entry share movement between the public company's primary transfer agent to the brokerage firm for sales of treasury shares directly from the public company (e.g., deposit/withdrawal at custodian process).

In this case of a treasury stock purchase, stock purchase engine 212 receives a stock quote price form the quote provider designated by the company to price treasury share purchases and prices purchases the shares using the third-party broker based on the average aggregate sales price of shares purchased or sold through the system on the particular trading day. In the case of an open market purchase, the market (via the broker designated by the public company) determines the price for purchasing and selling shares of stock. The funding of purchases by users is not limited to ACH transactions. It is within the scope of the technology described herein for a user to purchase stock from a company via other payment methods such as, but not limited to, a credit card.

Funds are moved from the user's account to the public company or to the brokerage firm for open-market purchases, and the stock is reflected in book-entry form on the system per user. Book entry is a system of tracking ownership of securities where no physical stock certificate is provided to the investor (user). The number of shares of stock purchased by the user, share price and purchase date and other data required by regulation are added as a record to the user's user profile stored in shareholder database 206.

At step 514, a confirmation of the stock purchase is delivered to the user. In some embodiments, system 120 delivers the confirmation (in the case of a registered plan, on behalf of the public company) to the user. At step 616, the stock purchase data is added as a record to the user's user profile maintained in shareholder database 206. In some embodiments, each record in the user profile represents a single stock transaction. By way of example only, a record contains details associated with the stock transaction such as, but not limited to, the date the trade was made, the execution price, when funding happened, when funding was initiated, the ACH funding batch it belonged to (if an ACH transaction), and the like. It is within the scope of the technology described herein for a record to contain other information or less information. Step 516 may occur prior to, or concurrently with, step 514.

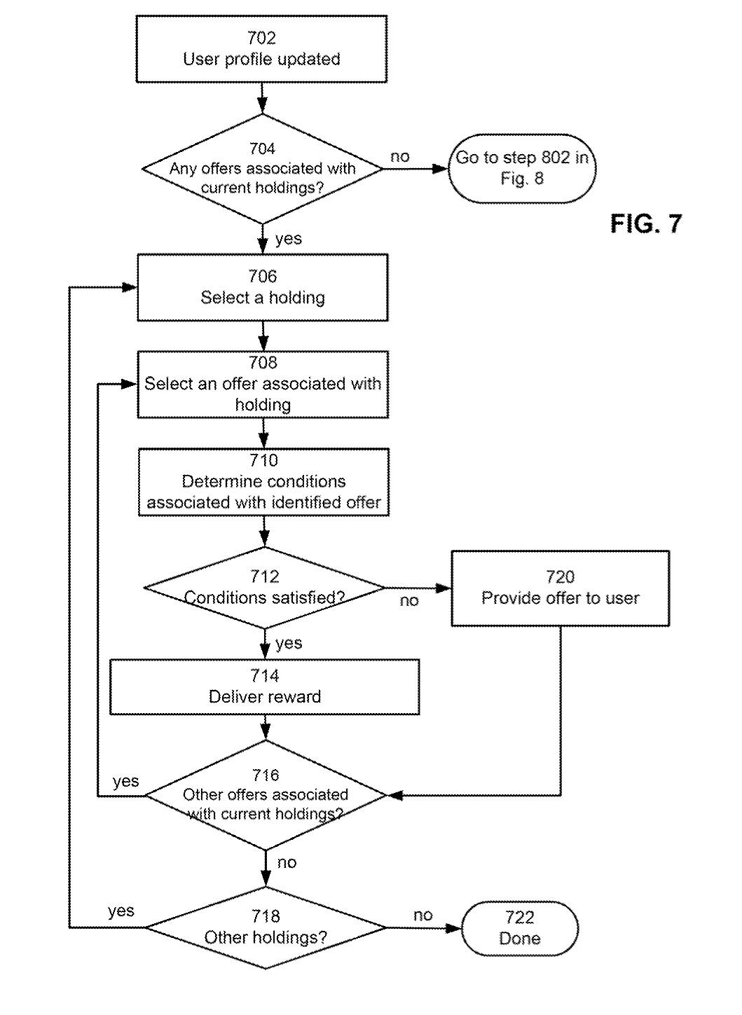

The user profile stored in shareholder database 206 can be periodically updated to ensure that the user profile in shareholder database 206 contains the most recent user information (e.g., personal information and investment account information). The term “periodically” is intended to refer to any time period. For example, the user profile may be updated every minute, every hour, several times per hour, several times per day, once every few days, and so on. These periods of time are exemplary only, and are not intended to limit the scope of the technology described herein. FIG. 7 illustrates exemplary steps for delivering an offer/reward to a user when a user profile stored in shareholder database 206 is updated. At step 702, system 120 identifies that a user profile has been updated.

At step 704, system 120 determines if any offers exist in the offer database 214 that are related to any of the stocks owned by the user (based on the data contained in the user profile). A current stock holding affiliated with an offer is selected, at step 706. In some embodiments, shareholder system 120 accesses shareholder database 206 and identifies a unique stock identifier associated with the user in a shareholder record. An offer associated with the stock is selected from the offer database, at step 708. By way of example only, system 120 determines if the selected stock identifier is located in offer database 214. Assuming that the stock identifier is found in offer database 214, the conditions of the offer are determined, at step 710. Using the example provided above, the condition of the offer promoted by Company A requires a user to own at least 1,000 shares of Company A stock.

System 120 determines if the conditions of the offer are satisfied, at step 712. System 120 makes this determination similar to as described above in reference to FIG. 6. If the conditions of the offer are satisfied, the system 120 delivers the reward to the user, at step 714. In some embodiments, system 120 does not deliver the reward, and instead delivers a notification to the company that provided the offer to deliver the reward to the user. In other embodiments, system 120 delivers a notification to a third-party vendor used by the company that provided the offer to deliver the reward to the user (e.g., printing, mailing or fulfillment house).

If the conditions of the offer are not satisfied, at step 712, system 120 provides the offer to the user, at step 720. The exemplary method shown in FIG. 4 is followed upon the user selecting the offer. After the offer is provided to the user, system 120 determines if other offers exist in the offer database 214 that are associated with any of the user's other stock holdings, at step 720.

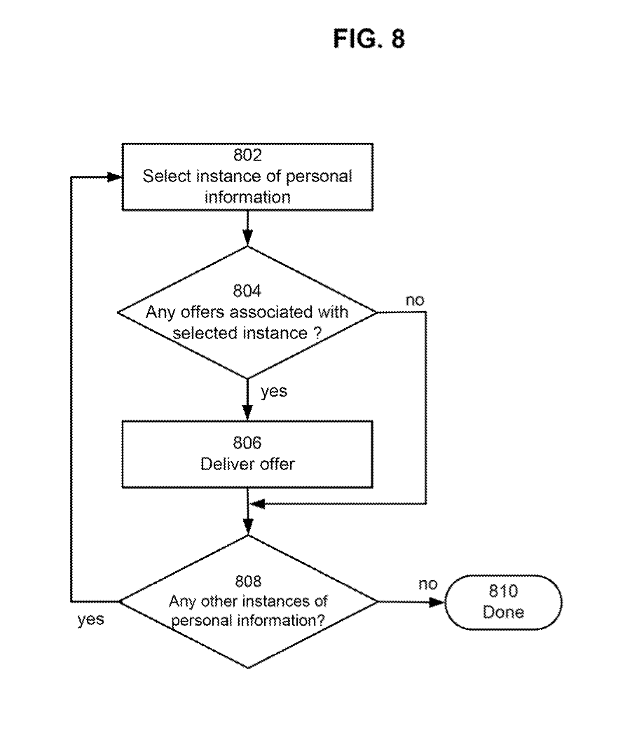

After delivering the reward (or offer), system 120 determines if other offers exist in the offer database 214 that are associated with the current stock holding, at step 716. It is within the scope of the technology described herein for a company to advertise several offers at a time. Suppose, for example, the offer selected at step 706 was the invitation-only event for users who own at least 1,000 shares of Company A stock. At step 704, system 120 may have identified more than one offer being provided by Company A. System 120, returning to step 708, selects a second offer (e.g., 15% off next purchase if user owns more than 200 shares of Company A stock). Steps 710-716 and 720 are repeated to determine if the reward or the offer should be delivered to the user. At step 718, system 120 determines if there are other holdings remaining that were identified at step 704 (e.g., Company B). If there are no other holdings with offers, the process shown in FIG. 8 is completed (step 722) until the next time the user profile is updated.

System 120 also determines if there are any offers in the offer database 214 related to at least one instance of the user's personal information in the user profile. FIG. 8 illustrates an exemplary method for identifying and delivering an offer, based on an instance of the user's personal information in the user profile, to a user. The process of FIG. 8 is based on an instance of the user's personal information contained in the user profile. At step 802, system 120 selects an instance of the user's personal information. By way of example only, personal information may include any information related to an account other than a brokerage account (e.g., bank account, loyalty program accounts, etc.), information about the user (e.g., date of birth, address, etc.), and the like. Upon selecting an instance of personal information, system 120 determines if any offers in the offer database 214 are related with the instance of personal information, at step 804. For example, suppose the user profile indicates that the user has a bank account with Bank A. System 120, at step 804, determines if the offer database 214 contains any offers associated with Bank A.

If there is an offer in the offer database 214 associated with Bank A, system 120 delivers the offer to the user, at step 806. In some embodiments, system 120 generates an electronic mail (email) message for delivery to the user, and the email message contains the electronic data associated with the offer. In one embodiment, the email message may contain a uniform resource link (URL) link to the offer. In other embodiments, the email message may contain the offer advertisement embedded in the email body. These offers are exemplary and are not intended to limit the scope of the technology described herein. By way of example only, the email message, with the offer, is delivered to the user's inbox. When the user opens the email message, the offer is presented to the user (e.g., embedded advertisement, message with a URL link to rich media content). When the user selects the offer (e.g., clicks on advertisement, clicks on URL link, etc.), system 120 determines if the user qualifies for the reward (see FIGS. 4-6).

After delivering the offer to the user, system 120 determines if the user profile contains other instances of the user's personal information, at step 808. If no further instances of personal information are available in the user profile, the offer delivery method shown in FIG. 8 is completed (step 810) until the next time the user profile is updated. If, however, another instance of personal information is available in the user profile, steps 802-806 are repeated. All instances of user information stored in the user profile do not have to be selected before the process shown in FIG. 8 is completed. It is within the scope of the technology described herein to select only certain predetermined instances of personal information.

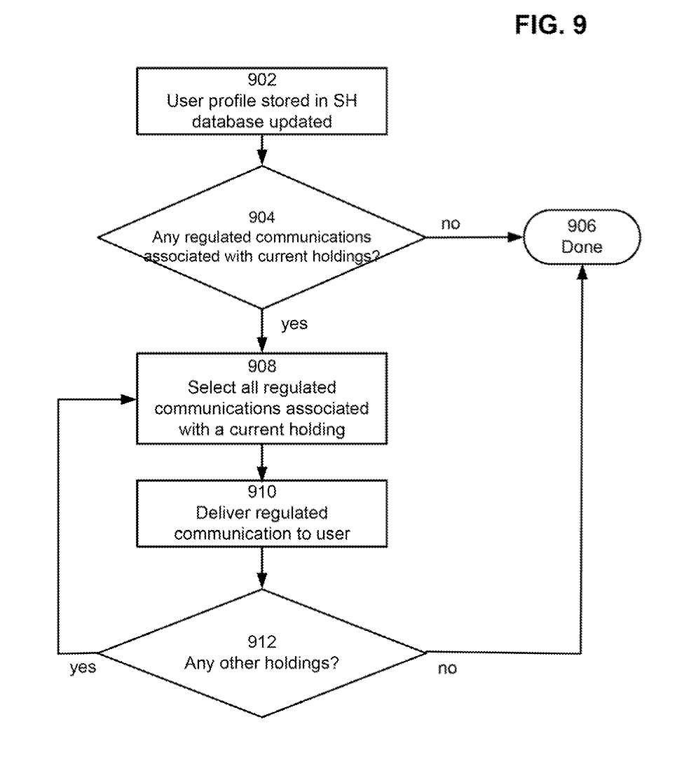

Public companies are required to deliver SEC regulated communications (e.g., annual reports, proxy materials, etc.) to their shareholders. FIG. 9 illustrates an exemplary method of how system 120 identifies SEC-regulated documents associated with one or more holdings owned by a shareholder, and for delivering those identified SEC-regulated communications directly to a shareholder (instead of delivering the documents to the broker, who then forwards the material on to the shareholder). In FIG. 9, system 120 checks for SEC-required documents every time a user profile is updated. In other embodiments, system 120 tracks and monitors public company notifications.

At step 902, the user profile that is stored in the shareholder database 206 is updated. As discussed above, the information contained in the user profile that may be updated includes stock purchase data and personal information data.

At step 904, system 120 determines whether there are any SEC regulated communications associated with any of the issuers of stock identified in the stock purchase data. For example, if the user profile in the shareholder database includes a record for Company A and Company B stock, system 120 determines if there are any SEC regulated documents related to Company A or Company B, at step 904. In some embodiments, there may be more than one SEC regulated document related to a single issuer of stock. Thus, at step 908, system 120 identifies all available SEC regulated documents for an issuer of stock (e.g., Company A).

At step 910, system 120 delivers the SEC regulated documents to the user. In some embodiments, the SEC documents are delivered to an inbox associated with the user. In other embodiments, to minimize the amount of data transmitted to a user, system 120 delivers a notification to the user indicating that one or more SEC regulated documents are available for viewing. By way of example only, system 120 delivers an email to the user containing a URL link to each of the SEC-based communications identified in the email. The user would then use his or her password to view and have the ability to download or print the document. In some embodiments, all registered users owning the current holding are identified and system 120 delivers the communication to all registered users, at step 910. If the user profile does not contain any holdings associated with an SEC document (step 904), the process shown in FIG. 9 is completed, at step 906.

At step 904, system 120 narrowed the list of holdings in the user profile down to the holdings that are associated with an offer. Thus, at step 912, system 120 determines whether any other holdings identified at step 904 remain. If at least one more holding remains, steps 908 and 910 are repeated. Otherwise, system 120 ends the document delivery service shown in FIG. 9, at step 906, until the user profile is updated again.

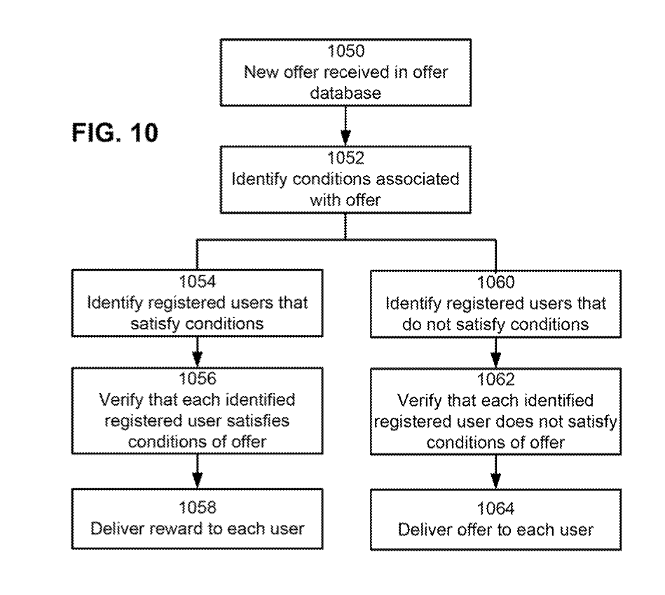

FIG. 10 illustrates an exemplary method for delivering rewards and offers to one or more users when a new offer is deposited in the offer database 214 by an issuer of stock (or third-party vendor on behalf of the issuer). Using the examples provided above, the rewards and/or offers may be delivered to a user in many ways. For example, via email, a text message, an instant message, or other means. At step 1050, system 120 detects that a new offer is deposited into the offer database 214. At step 1052, system 120 identifies the conditions of the offer (e.g., minimum number of shares of stock, attended a shareholder meeting, etc.). System 120 proceeds to divide the registered users into two groups: users that meet (or exceed) the conditions of the offer and user who do not meet the conditions of the offer. At step 1054, system 120 identifies registered users that meet (or exceed) the conditions of the offer. As discussed above, this determination is based on using the user information available in the user profile stored in the shareholder database 206 (which stored stock purchase data and personal information data for each user).

Upon identifying a user that meets the conditions of the offer, system 120 verifies that the user indeed satisfies the conditions, at step 1056. In some embodiments, system 120 updates the user profile stored in the database 206 for the user. Upon verifying that the user meets (or exceeds) the conditions of the offer, system 120 delivers the reward to the user, at step 1058. In some embodiments, a notification is sent to a fulfillment house indicating that the user meets the conditions of the offer and the reward should be delivered to the user on behalf of the issuer of stock.

System 120 also identifies registered users that do not satisfy the conditions of the offer, at step 1060. Again, this initial determination that the user does not at least meet the conditions of the offer is based in the user profile stored in the shareholder database. At step 1062, system verifies that each registered user identified at step 1060 does not at least meet the conditions of the offer. System 120 obtains stock purchase data from investment accounts and personal information from personal accounts before verifying that the user does not satisfy the conditions of the offer. By doing so, system 120 verifies whether the user qualifies for the reward based on the latest available stock purchase data and personal information data. It is not required for system 120 to update the user profile in the shareholder database every time steps 1056 and 1058 are performed. When it is verified, at step 1062, that the user does not satisfy the conditions of the offer, system 120 delivers the offer to the user, at step 1064. It is within the scope of the technology described herein to not deliver the offer to the user unless that user owns at least one share of the stock associated with the offer. Once an offer has been delivered to a user, the user may purchase sufficient shares associated with the offer (step 402 in FIG. 4).

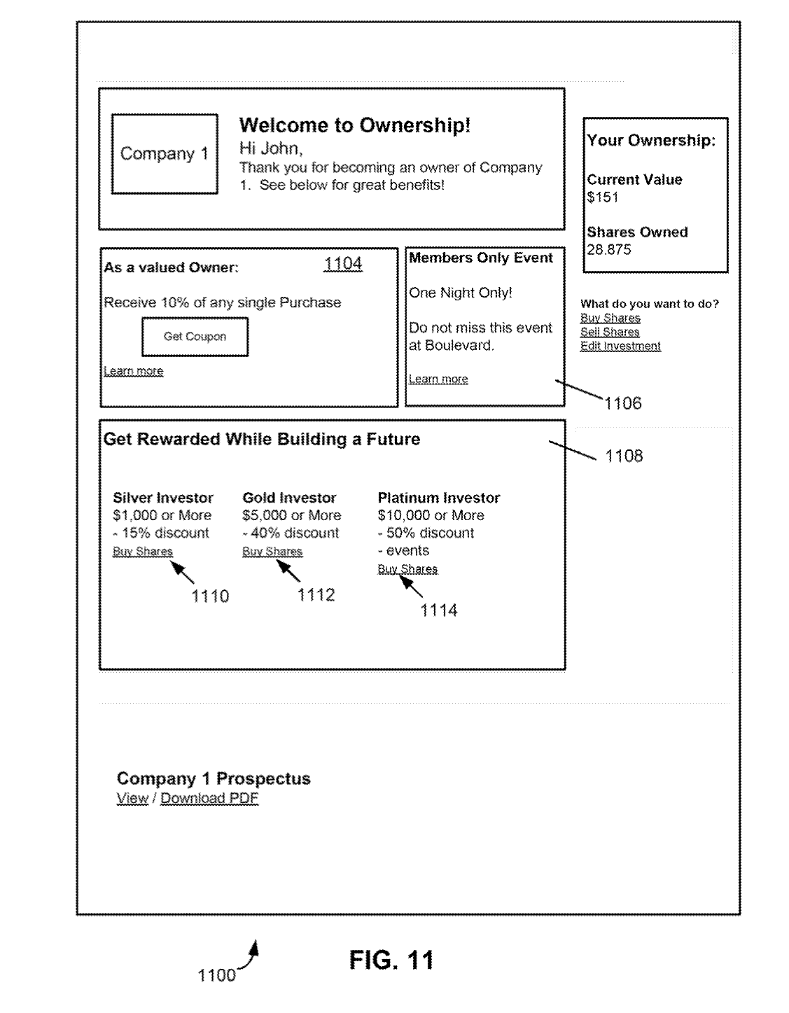

FIG. 11 illustrates an exemplary offer 1100 delivered to a processing device (e.g., laptop, smart phone, etc.) via network 120. In some embodiments, offer 1100 is an electronic message delivered to a user via email or other means. In other embodiments, offer 1100 is an electronic message delivered to the user's account within system 120. As discussed above, offer 1100 may have been delivered to the user by system 120, by the issuer, or by a third-party vendor used by the issuer. Offer 1100 may be in a format other than that shown in FIG. 11, and may be delivered to a user via text message, instant message, and the like.

Offer 1100 includes multiple promotions. Thus, offer 1100 is considered a single offer with multiple rewards. Window 1104 advertises a first promotion, offering a 10% discount on any single purchase. Window 1106 advertises a second promotion, advertising an invitation only event. Window 1108 advertises three additional promotions. A user may become a Silver investor upon owning $1,000 or more Company 1 stock. In return, the user receives a 15% discount on their next purchase at Company 1. A user may become a Gold investor upon owning $5,000 or more of Company 1 stock. In return, the user receives a 40% discount on their next purchase at Company 1. A user may become a Platinum investor upon owning $10,000 or more of Company 1 stock. In return, the user receives a 50% discount on their next purchase at Company 1 and is invited to select Company 1 events. Offer 110 is exemplary only and is not intended to limit the scope of the technology described herein. Offer 1110 may include only a single promotion and/or may advertise different rewards than those shown in FIG. 11.

Using the exemplary offer 1100 shown in FIG. 11, system 120 detects that the user selected the Silver investor promotion of offer 1100 upon the user selecting “buy shares” link 1110 (step 502 in FIG. 4). System 120 then begins the reward delivery process shown in FIG. 4. In this instance, the offer rule requires the user to own $1,000 or more of Company 1 stock and the reward is a 15% discount for a single purchase. The reward may be a promotional code, a discount code, a coupon sent to the user in the mail, and the like. Selecting links 1112 or 1114 will also begin the reward delivery process shown in FIG. 4.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer implemented method for providing a reward to a user, comprising the steps of:
electronically receiving data indicating that a user has selected an offer to receive a reward from an issuer of stock, wherein the offer is associated with one or more conditions that must be satisfied in order to receive the reward;
identifying the one or more conditions associated with the offer, wherein the offer is stored in an offer database;
determining whether the one or more conditions associated with the offer are satisfied based on stock purchase data contained within a user profile record associated with the user that is stored in a shareholder database, wherein the stock purchase data stored in the shareholder database represents stock purchases made by the user via one or more investment accounts and stock purchased by the user directly from the issuer of stock;
upon determining that the one or more conditions of the offer are satisfied based on the stock purchase data contained in the user profile record associated with the user stored in the shareholder database, determining the reward associated with the offer;
generating a message containing the reward for delivery to the user; and
delivering the generated message containing the reward to the user.

2. The computer implemented method as recited in claim 1, further comprising:
upon determining that the one or more conditions of the offer are not satisfied based on the stock purchase data stored in the shareholder database, delivering a second offer to the user providing the user the opportunity to satisfy the one or more conditions of the offer.

3. The computer implemented method as recited in claim 2, wherein the second offer is an offer to purchase stock directly from the issuer of stock or to buy the stock through an intermediary financial account that has data linked to the user profile record.

4. The computer implemented method as recited in claim 1, wherein the step of determining whether the one or more conditions are satisfied comprises:
when the one or more conditions of the offer are not satisfied based on the stock purchase data stored in the shareholder database, identifying at least one external investment account associated with the user;
accessing the at least one identified external investment account associated with the user to confirm stock purchase data associated with the external investment account;
aggregating the stock purchase data stored in the shareholder database with the new stock purchase data obtained from the external investment account; and
determining whether the one or more conditions of the offer are satisfied based on the aggregated stock purchase data stored in the shareholder database.

5. The computer implemented method as recited in claim 1, wherein the step of determining whether the one or more conditions are satisfied comprises:
when the one or more conditions of the offer are not satisfied based on the stock purchase data stored in the shareholder database, identifying at least one external investment account associated with the user;
obtaining new stock purchase data from the external investment account;
aggregating the stock purchase data in the shareholder database with the new stock purchase data obtained from the external investment account; and
determining whether the one or more conditions of the offer are satisfied based on the aggregated stock purchase data.

6. The computer implemented method as recited in claim 1, wherein the one or more conditions of the offer includes one or more of the following conditions:
the user must own a minimum number of shares of stock associated with the issuer that provided the offer;
the user must own a minimum number of shares of stock associated with the issuer that provided the offer for a minimum period of time; or
the user must have participated in a shareholder activity.

7. The computer implemented method as recited in claim 1, wherein the step of generating a message containing the reward for delivery to the user comprises generating a message for delivery to the user via one of the following communication mediums: an email message, a text message, an instant message, regular mail, a telephone call, a pop-up window, and a mobile phone application.

8. The computer implemented method as recited in claim 7, wherein a reward comprises one of the following: a promotional code, a discount code, an invitation to an event, a rebate, shares of stock, access to an exclusive product, access to information, access to content, access to a service, and access to company during shareholder only hours.

9. The computer implemented method as recited in claim 1, wherein the step of delivering the generated message to the user comprises:
delivering a notification to the issuer of stock indicating that the one or more conditions of the offer have been satisfied and the issuer of the stock should deliver the reward to the user.

10. A computer implemented method for incentivizing a user to purchase stock directly from an issuer, comprising the steps of:
electronically providing an offer to a client, wherein the offer advertises that an issuer of stock will provide a reward upon verification of ownership of a predetermined number of shares of stock;
detecting input indicating that a user has selected the offer, wherein the user selects the offer via the client;
upon determining that the number of shares of stock owned by the user does not meet or exceed the predetermined number of shares of stock required to receive the reward based on stock purchase data stored in a shareholder database, delivering a second offer to the client providing an opportunity to purchase additional shares of stock from the issuer;
when the user selects the second offer, causing a stock purchase transaction of additional shares of stock associated with the issuer;
aggregating stock purchase data associated with the additional shares of stock purchased by the user from the issuer with preexisting stock purchase data stored in the shareholder database;
verifying that the number of shares of stock owned by the user meets or exceeds the predetermined number of shares of stock required to receive the reward based on the aggregated stock purchase data; and
delivering the reward to the client based on verifying that the number of shares of stock owned by the user meets or exceeds the predetermined number of shares of stock required to receive the reward based on the aggregated stock purchase data.

11. The method as recited in claim 10, wherein the step of causing a stock purchase transaction of additional shares of stock comprises:
providing a user interface that allows the user to designate an investment amount; and
causing the purchase of shares under a direct stock purchase plan through the purchase of treasury stock from the public company or through an open-market purchase.

12. The method as recited in claim 10, wherein the step of causing a stock purchase transaction of additional shares of stock comprises:
providing a user interface that allows the user to designate an investment amount;
identifying a third-party broker designated by the issuer for custodying securities and for executing the stock purchase as an open-market stock transaction; and
providing electronic instructions to the third-party broker to execute an open-market stock transaction for the investment amount.

13. The method as recited in claim 10, wherein the step of electronically providing an offer to a client comprises:
obtaining stock purchase data from at least one external investment account associated with the user;
updating the preexisting stock purchase data stored in the shareholder database with the stock purchase data obtained from the at least one external investment account;
selecting an offer based on the updated stock purchase data stored in the shareholder database; and
delivering the selected offer to the client.

14. The method as recited in claim 10, wherein the step of electronically providing an offer to a client comprises:
identifying an instance of personal information data associated with the user stored in the shareholder database;
selecting the issuer associated with the identified instance of personal information;
selecting an offer associated with the issuer; and
delivering the offer to the client.

15. The method as recited in claim 13, wherein the step of delivering the reward to the user comprises:
delivering a notification to a third-party vendor associated with the issuer, the notification indicating that the reward associated with the offer should be delivered to the client.

16. A computer implemented method for providing a reward to a user, comprising the steps of:
storing access data for at least one investment account associated with a user in a user profile record in a shareholder database, the access data provided by the user during a registration process;
using the access data stored in the user profile record in the shareholder database, periodically obtaining stock ownership data from the at least one investment account associated with the user;
aggregating the stock ownership data obtained from the at least one investment account with existing stock ownership data stored in the user profile record in the shareholder database;
selecting an offer based on the aggregated stock ownership data in the user profile record in the shareholder database, wherein the offer advertises receiving a reward upon meeting conditions set forth in the offer;
delivering an electronic message containing the selected offer to the user;
upon selection of the offer by the user, verifying that the user meets or exceeds the conditions set forth in the offer based on the aggregated stock ownership data stored in the user profile record in the shareholder database; and
delivering the reward to the user based on verifying that the user meets or exceeds the conditions set forth in the offer.

17. The computer-implemented method as recited in claim 16, wherein the step of verifying that the user meets or exceeds the conditions set forth in the offer comprises:
determining the conditions set forth in the offer;
identifying the instances of aggregated stock ownership data related to the conditions set forth in the offer;
comparing the instances of aggregated stock ownership data against the conditions set forth in the offer;
when the instances of aggregated stock ownership data meets or exceeds the conditions set forth in the offer, determining that the user qualifies for the reward; and
when the instances of aggregated stock ownership data does not meet or exceed the conditions set forth in the offer, delivering a second offer to the user.

18. The computer implemented method as recited in claim 17, wherein the step of delivering a second offer to the user comprises:
delivering a second offer to the user providing the opportunity to qualify for the reward.

19. The computer implemented method as recited in claim 16, wherein the step of delivering the reward to the user comprises:
electronically delivering a notification to a fulfillment house indicating that the conditions of the offer have been satisfied by the user, wherein the fulfillment house is associated with an issuer of stock and delivers the reward to the user on behalf of the issuer of stock.

20. The computer implemented method as recited in claim 16, wherein the aggregated stock ownership data includes data identifying at least one issuer of stock, the step of selecting an offer based on the aggregated stock ownership data in the shareholder database comprises:
selecting an issuer of stock;
determining whether an offer exists in an offer database that is related to the selected issuer of stock;
when there is an offer related to the selected issuer of stock, retrieving the offer from the offer database and delivering the offer to the user.
